(19) United States
(12) Patent Application Publication
(10) Pub. No.: US 2007/0047216 A1
(43) Pub. Date: Mar. 1, 2007

(54) Glow stick holder

(76) Inventor: Paul Piazzolla, Pompano Beach, FL (US)

Correspondence Address: ROBERT M. DOWNEY, P.A., 6751 N. FEDERAL HWY., SUITE 300, BOCA RATON, FL, 33487, US

(21) Appl. No.: 11/510,231

(22) Filed: Aug. 25, 2006

Related U.S. Application Data
(60) Provisional application No. 60/711,965, filed on Aug. 26, 2005.

(51) Int. Cl. F21K 2/00

(52) U.S. Cl. 362/34

(57) ABSTRACT

A device for holding a chemiluminescent glow stick mounts to an article such as, but not limited to, a skateboard, an inline roller skate, a snow ski or the like. In one embodiment, the device has an open ended transparent tube for interlocking receipt of the glow stick therein. In another embodiment, a semi-cylindrical clip is sized, structured and disposed before snap fit grasping receipt of the glow stick. One or more brackets have a collar that surrounds and holds the tube or semi-cylindrical clip, and a mounting flange for attaching the bracket to the article using, for instance, screws, hook and loop fasteners, or an adhesive. Alternatively, the brackets may directly hold the glow stick. In this instance, the collar of the bracket is signed for grasping receipt of the glow stick.

This application is based on provisional patent application Ser. No. 60/711,965 filed on Aug. 26, 2005 and I claim the benefit of the provisional patent application filing date under Title 35, United Stated Code section 119 (e).

### BACKGROUND OF THE INVENTION

1. Field of the Invention

The present invention relates generally to mounting brackets for holding elongate cylindrical objects and, more particularly, to a device that mounts to an article and releasably holds a conventional glow stick.

2. Discussion of the Related Art

Glow sticks or light sticks are well known and are often used for safety purposes (e.g. pedestrians crossing roads at night), at children's parties and when scuba diving in dark conditions. Glow sticks are commonly manufactured to include an outer elongate cylindrical housing that is formed of a flexible plastic material. The outer housing is sealed and includes a hollow interior chamber. The hollow chamber of the housing is filled with an organic oxalate, a fluorescent dye solution and a glass ampule that is filled with hydrogen peroxide. When the outer housing of the glow stick is flexed, the glass ampule inside of the stick breaks, resulting in mixing and reaction of the organic oxalate with the hydrogen peroxide. Fluorophors in this reaction provide a brilliant light emitting color that typically lasts for 3-5 hours.

Use of glow sticks is presently limited to holding the stick in one's hand or placing the stick on a surface. There are no bracket devices in the related art that are specifically adapted for mounting a conventional glow stick to an article. More particularly, there remains a need for a bracket device that mounts to an article such as a skateboard, inline skate or snow ski, and wherein the bracket device is specifically structured for releasably holding a conventional glow stick to provide a novel and aesthetically appealing luminous affect.

### OBJECTS AND ADVANTAGES OF THE INVENTION

It is a primary object of the present invention to provide a device for mounting a conventional glow stick to an article, and wherein the device is structured and disposed to releasably hold the glow stick, thereby allowing expended glow sticks to be easily removed and replaced with new, fully charged glow sticks.

It is a further object of the present invention to provide a glow stick holder device which is adapted to be mounted to a moving article, such as skateboard, inline roller skate or snow ski to provide a novel, aesthically appealing luminous affect as the article moves.

Is still a further object of the present invention to provide a glow stick holder device which easily mounts to any desired article, and wherein the device is structured and disposed for universal fit of glow sticks of various manufacturers.

It is still a further object of the present invention to provide a glow stick holder device which is easy to mount to any desired article, and which allows for quick and easy placement and removal of a glow stick, thereby allowing for easy replacement of new glow sticks as needed.

These and other objects and advantages of the present invention are more readily apparent with reference to the detail description and the accompanying drawings.

### SUMMARY OF THE INVENTION

The present invention is directed to a device for holding a chemiluminescent glow stick. The device mounts to an article such as, but not limited to, a skateboard, an inline roller skate, a snow ski or the like. In one embodiment, the device has an open ended transparent tube for interlocking receipt of the glow stick therein. In another embodiment, a semi-cylindrical clip is sized, structured and disposed before snap fit grasping receipt of the glow stick. One or more brackets have a collar that surrounds and holds the tube or semi-cylindrical clip, and a mounting flange for attaching the bracket to the article using, for instance, screws, hook and loop fasteners, or an adhesive. Alternatively, the brackets may be used to directly hold the glow stick. In this instance, the collars of the brackets are sized for snug-fitted grasping receipt of the glow stick.

### BRIEF DESCRIPTION OF THE DRAWINGS

For a fuller understanding of the nature of the present invention, reference should be made to the following detailed description taken in conjunction with the accompanying drawings in which:

FIG. 1 is a bottom perspective view of a skateboard showing two glow sticks mounted to the bottom of the skateboard using the holder device of the present invention;

FIG. 2 is a rear perspective view of an inline roller skate showing a glow stick mounted to the side of the roller brace using the holder device of the present invention;

FIG. 3 is a plan view of the glow stick holder device, shown in partial cross-section, in accordance with one embodiment thereof;

FIG. 4 is a plan view of the glow stick holder device, in accordance with the embodiment of FIG. 3, showing use of a single mounting bracket;

FIG. 5 is a plan view of the glow stick holder device of the present invention, illustrating a second embodiment having a semi-cylindrical elongate clip for snap-fit releasable receipt of a glow stick therein;

FIG. 6 is a plan view illustrating yet another embodiment of the glow stick holder device which uses one or more brackets having a circular collar sized and configured for snug-fitted receipt of a glow stick therein;

FIG. 7 is a cross-sectional view taken along the line indicated by the arrows 7-7 in FIG. 3;

FIG. 8 is a cross-sectional view taken along the line indicated by the arrows 8-8 in FIG. 5.

Like reference numerals refer to like parts throughout the several views of the drawings.

### DETAILED DESCRIPTION OF THE PREFERRED EMBODIMENTS

Referring to the several views of the drawings, the glow stick holding device of the present invention is shown in accordance with several embodiments thereof and is generally indicated as 10.

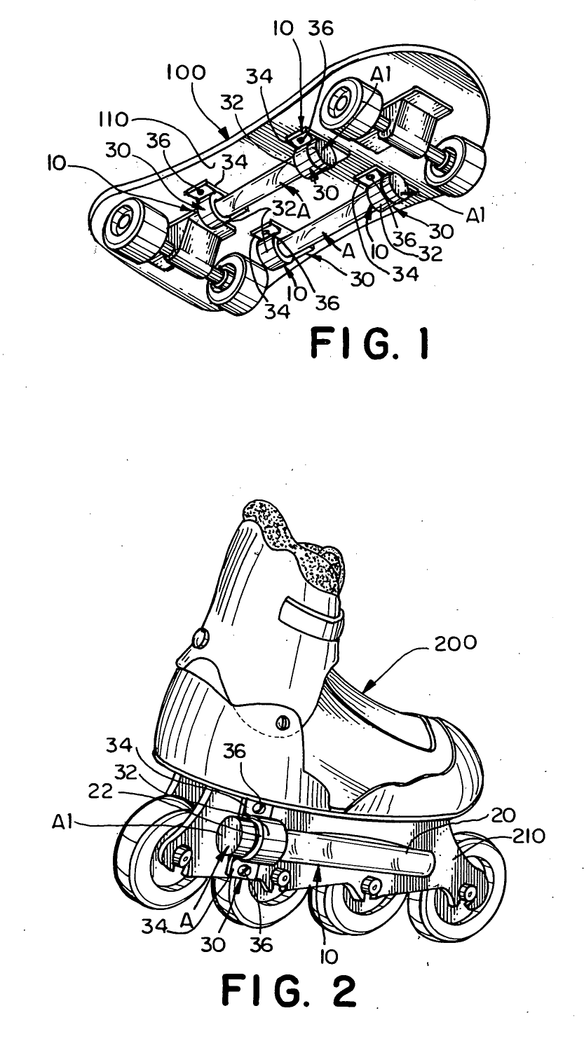

In FIG. 1, the glow stick holding device 10 is shown in use to mount conventional glow sticks A to the underside 110 of a skate board 100. The holding device 10 uses one or more brackets 30. Each bracket includes a circular collar 32 sized for snug-fitted receipt of the glow stick therein, and a mounting flange 34 having a flat surface for mating, attaching engagement with the surface of the article 100. In this particular example, the mounting flange 34 mates against the underside surface 110 of the skateboard 100 and conventional fasteners such as screws 36, hook and loop material or an adhesive is used to secure the bracket 30 to the skateboard.

In use, each glow stick A is activated by bending the outer flexible housing to break the internal glass ampule, thereby causing the chemical reaction to produce the chemiluminescent glow that may last for up to 6 hours. Once activated, each glow stick A is inserted within the respective brackets 30 which have been previously fastened to the underside of the skateboard 100. When held as shown in FIG. 1, the glow sticks emit a brilliant luminous glow which shines down onto the underlying ground surface. As the skateboard moves, the glow under the skateboard travels along the ground producing a unique visual affect. To enhance the visual effects of the chemiluminescent glow sticks, openings, such as elongate slots or shapes, can be cut through the skateboard, thereby allowing the luminous glow to shine up through the openings.

FIG. 2 shows another embodiment of the glow stick holder device 10 which uses a transparent tube 20 having an open end 22 sized for receipt of the glow stick A therethrough. The transparent tube is hollow and maybe closed at the opposite end. The interior of the transparent tube 20 is specifically shaped for congruent receipt of the glow stick A therein, and may be provided with an area of reduced diameter at the inner opposite end to provide a friction fit or snap-fit with the end of the glow stick, thereby holding the glow stick A within the transparent tube 20. It is noted that many conventional glow sticks A include an enlarged head A1. In this example, the enlarged head A1 remains on the exterior of the transparent tube 20 and allows the user to grasp the head A1 to insert and remove the glow stick A within the tube 20. A bracket 30, similar to that described in connection with FIG. 1, is used to secure the transparent tube 20 to a particular article. In this instance, a single bracket 30 is shown used for mounting the transparent tube 20 to the side face of the wheel brace 210 of an inline roller skate 200. The bracket 30 includes a circular collar 32 which fits tightly about the exterior of the tube 20 to thereby hold the tube 20 in fixed position. The flange 34 of the bracket 30 mounts against the side face of the wheel brace 210. Conventional fasteners, such as screws 36, hook and loop fastening material 38 or an adhesive can be used to fix the bracket 30 to the wheel brace 210 or other article surface.

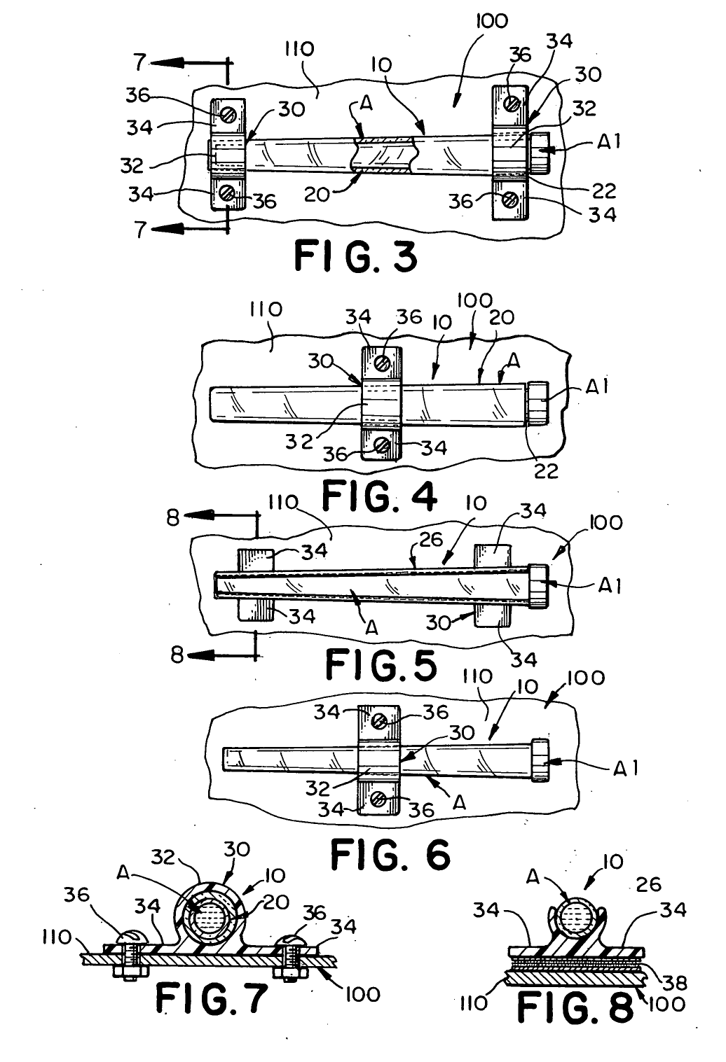

FIG. 3 illustrates an embodiment of the glow stick holding device 10 consistent with that shown in FIG. 2. In this instance, the transparent tube 20 is held at opposite ends with brackets 30. The brackets 30 fasten to the surface of an article, such as the skateboard 100 or inline skate 200. It should be noted that the particular article to which the glow stick holding device 10 mounts is not limited to those shown in the drawings and described herein. The illustration and description of a skateboard, inline roller skates, or snow ski is for purposes of example only and is not intended to limit the scope of use of the invention.

FIG. 4 illustrates mounting of the transparent tube 20 to a surface 110 of an article 100 with the use of a single bracket 30 at the center of the transparent tube 20.

FIG. 5 illustrates another embodiment of the glow stick holder device 10 which uses a semi-cylindrical clip 26 that is sized, configured, structured and disposed for snap-fit grasping receipt of the glow stick A therein. In cross-section, the clip 26 has a C shape which is specifically sized to grasp the outer cylindrical surface of the glow stick A. It is noted that the outer diameter of many glow sticks tapers from one end, where the enlarged head A1 is located, to the opposite end. In this instance, the elongate, semi-cylindrical clip 26 or the transparent tube 20 (described above) may be manufactured to include the same degree of taper, thereby providing a congruent fit with the exterior shape of the glow stick.

Alternatively, the brackets 30 may be made for direct attachment with the glow stick A. In this instance, the brackets may be made in different sizes to accommodate the tapering outer diameter of the glow stick A. Specifically, the circular collar 32 may be provided with an inner diameter specifically sized for snug-fitted, grasping attachment about a specific area of the glow stick A. For example, a smaller circular collar 32 may be provided for attachment to one end of the glow stick A, while a larger circular collar 32 may be provided for attachment to the opposite end of the glow stick A, as seen in FIG. 1.

It is further noted that the elongate, semi-cylindrical clip 26 of the embodiment shown in FIG. 5 may be manufactured to be much shorter, generally the same width as the bracket mounting flange 32, to provide for a more universal snap-fit to varying size glow sticks. Specifically, a reduced width C-shaped clip of this nature would allow for positioning along any portion of the length of the glow stick where a tight fit is achieved. A reduced width C-shaped clip would also allow for ease of mounting in instances where there is restricted access, as well as ease of replacement and removal of the glow stick in locations where it might otherwise be difficult to manipulate and remove the glow stick, such as between the forward and rear wheels of a skateboard.

As described above, a variety of means for securing the brackets 30 to an article are contemplated including, but not limited to, use of screws, bolts and nuts (see FIG. 7), hook and loop fasteners 38 (see FIG. 8), adhesives and other known and suitable means of attachment.

While the present invention has been shown and described in accordance with several preferred and practical embodiments thereof, it is recognized that departures from the instant disclosure are contemplated when the spirit and scope of the present invention.

What is claimed is:

1. A device for holding a chemiluminescent glow stick on an article comprising:
at least one bracket structured and disposed to at least partially surround the glow stick; and
said at least one bracket including a mounting flange with a flat surface for mating, attached engagement with the article to hold the glow stick on the article.

2. The device as recited in claim 1 further comprising:
a plurality of said brackets structured and disposed to at least partially surround the glow stick at spaced intervals along a length of the glow stick; and
each of said plurality of said brackets including said mounting flange.

3. The device as recited in claim 1 wherein said at least one bracket is structured and disposed for snap fit attachment to the glow stick.

4. The device as recited in claim 1 further comprising:
a holder structured and disposed for holding the glow stick therein; and
said at least one bracket is structured and disposed for attachment to said holder.

5. The device as recited in claim 4 wherein said holder is tubular.

6. The device as recited in claim 5 wherein said tubular holder includes an interior cavity sized and configured for congruent receipt of the glow stick therein.

7. The device as recited in claim 6 wherein said tubular holder includes an end portion within said interior cavity and said end portion being structured and disposed for snap fit attachment with the glow stick to releasably hold the glow stick within said interior cavity of said tubular holder.

8. The device as recited in claim 7 wherein said at least one bracket includes a collar that is sized, structured and configured for grasping attachment about an exterior of said tubular holder.

9. The device as recited in claim 8 further comprising:
a plurality of said brackets each including said collar for grasping attachment about an exterior of said tubular holder at spaced intervals along a length of said holder.

10. The device as recited in claim 5 wherein said tubular holder is transparent.

11. The device as recited in claim 4 wherein said holder is an open elongate U-shaped channel that is sized structured and configured for releasable grasping receipt of the glow stick therein.

12. The device as recited in claim 1 wherein said mounting flange is attached to the article using at least one screw fastener.

13. The device as recited in claim 1 wherein said mounting flange is attached to the article using hook and loop fasteners.

14. The device as recited in claim 11 wherein said open elongate U-shaped channel is transparent.

15. A device for holding a chemiluminescent glow stick on an article comprising:
a holder structured and disposed for releasably holding the glow stick;
at least one bracket for mounting said holder to the article; and
said at least one bracket including a mounting flange for mating, attached engagement with the article to hold the glow stick on the article.

16. The device as recited in claim 15 wherein said holder comprises:
a tubular body including an interior cavity sized and configured for congruent receipt of the glow stick therein.

17. The device as recited in claim 15 wherein said holder comprises:
an open elongate U-shaped channel sized, structured and configured for releasable grasping receipt of the glow stick therein.

18. The device as recited in claim 15 wherein said holder is transparent.
